(19) United States
(12) Patent Application Publication
(10) Pub. No.: US 2026/0235095 A1
(43) Pub. Date: Aug. 13, 2026

(54) INTERNAL COMBUSTION ENGINE

(71) Applicant: Satoshi ANZAI, Kanagawa (JP)

(72) Inventor: Satoshi ANZAI, Kanagawa (JP)

(21) Appl. No.: 19/168,928

(22) PCT Filed: Mar. 26, 2024
(86) PCT No.: PCT/JP2024/011920

§ 371 Date: Sep. 25, 2025

(30) Foreign Application Priority Data
Mar. 31, 2023 (JP) 2023-058804

(51) Int. Cl. F02M 25/12

(52) U.S. Cl. CPC F02M 25/12

(57) ABSTRACT

Provided is an internal combustion engine in which combustion efficiency is improved with fuel reformed by mixing fine bubbles. The internal combustion engine is provided with a fuel supply passage through which the fuel from the fuel tank is supplied to the engine body; and a fine bubble generation device that is disposed in the midway of the fuel supply passage and that discharges multiple gaseous bodies in the form of fine bubbles. The fine bubble generation device is provided with fine bubble generation media, that are porous material. The fine bubble generation media are each provided with a main surface that has the largest area on a surface parallel to the direction in which the fuel flows in the fuel supply passage.

### TECHNICAL FIELD

The present invention relates to a technique for an internal combustion engine including means for supplying reformed fuel resultant of reforming a fuel in a fuel tank.

### BACKGROUND ART

In recent years, a technique using fine bubbles, having bubble sizes (diameters) smaller than 100 μm at normal temperature and normal pressure, in liquid has attracted attention. Fine bubbles have physicochemical characteristics such as having very large surface areas and exhibiting a self-pressurizing effect, and, by making use of these characteristics, techniques using fine bubbles in wastewater treatment, cleaning, gas dissolution, mixing, and the like have been developed.

As a generator of fine bubbles with such characteristics, a fine bubble generation device including a passage for passing liquid, a compressor that pressure-feeds a gaseous body into the passage, and a fine bubble generation medium that discharges the gaseous body having been pressure-fed by the compressor, in the form of fine bubbles, into the liquid in the passage has been known (see, for example, Patent Literature 1).

Also known is an internal combustion engine, such as a diesel engine, provided with a fuel reforming device configured to reform a liquid fuel into a fuel having better combustibility, by mixing fine bubbles into the liquid fuel. For diesel engines, a technique for increasing the amount of oxygen dissolved in fuel by mixing a gaseous body containing oxygen into the fuel in advance, for the purpose of improving the engine combustion and reducing harmful exhaust gas, has been known (see, for example, Patent Literature 1).

A conventional fuel reforming device includes: a pump that pressurizes liquid fuel; a nozzle that receives supplies of the liquid fuel having been pressurized by the pump and a gaseous body, that mixes and stirs the liquid fuel with the gaseous body to form fine bubbles of the gaseous body in the liquid fuel, and then sprays the resultant liquid fuel into a storage tank; and a reformed fuel feeder that extracts the reformed fuel stored in the storage tank and feeds the reformed fuel into a combustor.

### CITATIONS LIST

### Patent Literature

Patent Literature 1: JP-B 6815397 Gazette

Patent Literature 2: JP-U 3203452 Gazette

### SUMMARY OF INVENTION

### Technical Problems

While the conventional reformed fuel device uses the air, oxygen, ozone, or hydrogen gas as the gaseous body to be mixed, the fuel reforming effect achieved by supplying hydrogen gas or oxygen gas alone is low; therefore, it is desirable for the fuel reforming device to mix two types of gaseous bodies with the fuel.

Furthermore, these two types of gaseous bodies can be supplied sufficiently by collecting these types of gaseous bodies from the water or the air existing in nature, as the raw material gas. Furthermore, in a case where hydrogen gas and oxygen gas are mixed with each other and the mixture is then mixed with the fuel, if large amounts of hydrogen gas and oxygen gas are supplied into the fuel as large-size bubbles, the gas may become combusted in the fuel, and may cause the fuel supply passage or the diesel engine body to break.

Therefore, in view of such problems, the present invention provides an internal combustion engine in which combustion efficiency is improved with fuel reformed by mixing fine bubbles therein, so that it is possible to suppress generation of harmful gas generated as a result of incomplete combustion of nitrogen oxide, carbon monoxide, and the like.

### Solutions to Problems

The problems to be solved by the present invention have been described so far, and means for solving the problem will now be explained.

That is, provided according to the present invention is an internal combustion engine that generates reformed fuel by mixing a gaseous body in a form of fine bubbles with a fuel from a fuel tank, and supplies the reformed fuel into an engine body, the internal combustion engine including:

a fuel supply passage through which the fuel is supplied from the fuel tank to the engine body; and a fine bubble generation device that discharges a plurality of gaseous bodies in a form of fine bubbles to the fuel to be supplied to the engine body, wherein

the fine bubble generation device includes a fine bubble generation medium that is a porous material, and

the fine bubble generation medium has a main surface having a largest area on a surface parallel with a direction in which the fuel flows.

In the present invention, the fine bubble generation device is disposed in the midway of the fuel supply passage.

In the present invention, a plurality of internal spaces into which two or more gaseous bodies are supplied may be formed, and
by discharging a plurality of different types of gaseous bodies from the plurality of respective internal spaces, a plurality of gaseous bodies are discharged in the form of fine bubbles.

In the present invention, the fine bubble generation device may include a plurality of fine bubble generation media, and the plurality of fine bubble generation media may have respective surface areas that are different from each other.

In the present invention, the gaseous bodies supplied to the fine bubble generation device may be hydrogen and oxygen.

In the present invention, an electrolyzer that generates hydrogen and oxygen by electrolyzing water may be provided, and
the hydrogen and the oxygen to be supplied to the fine bubble generation device may be supplied from the electrolyzer.

In the present invention, an air separator that separates air from exhaust gas of the internal combustion engine may be provided, and
the air may be supplied from the air separator to the fuel supply passage.

### Advantageous Effects of Invention

As advantageous effects of the present invention, the following effects are achieved.

In the present invention, combustion efficiency is improved with fuel reformed by mixing fine bubbles therein from a fine bubble generation device disposed in a fuel supply passage, so that it is possible to suppress generation of harmful gas generated as a result of incomplete combustion of nitrogen oxide, carbon monoxide, and the like. Furthermore, by providing a plurality of fine bubble generation devices and causing each of the fine bubble generation devices to generate a gaseous body, it is possible to supply gaseous bodies that may combust by getting mixed, such as hydrogen and oxygen, individually, so that it is possible to mix the gaseous bodies at various ratios, and to formulate a reformed fuel enabled to improve the performance of the engine body.

### BRIEF DESCRIPTION OF DRAWINGS

FIG. 1 is a schematic diagram illustrating an internal combustion engine according to a first embodiment.

FIG. 2 is a perspective view illustrating fine bubble generation media in a fuel supply passage.

FIG. 3 is a side view illustrating an internal combustion engine according to a second embodiment.

FIG. 4 is a side cross-sectional view illustrating a fine bubble generation device according to a third embodiment.

FIG. 5 is a side cross-sectional view illustrating a fine bubble generation device according to a fourth embodiment.

FIG. 6 is a side view illustrating a service tank and a fine bubble generation device according to a fifth embodiment.

FIG. 7 is a side view illustrating a service tank and a fine bubble generation device according to a sixth embodiment.

### DESCRIPTION OF EMBODIMENTS

### First Embodiment

Embodiments of the present invention will now be explained.

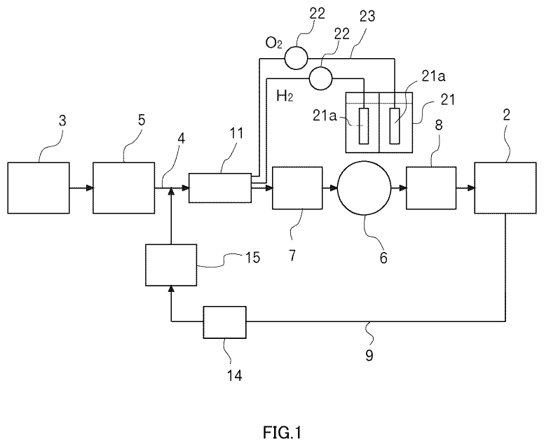

To begin with, the overall configuration of an internal combustion engine according to an embodiment of the present invention will be explained with reference to FIG. 1.

As illustrated in FIG. 1, this internal combustion engine 1 includes an engine body 2, a fuel tank 3 where the fuel to be supplied into the engine body 2 is stored, and a fuel supply passage 4 that connects the fuel tank 3 to the engine body 2 so as to pass the fuel supplied from the fuel tank 3.

The engine body 2 is a diesel engine, for example, and is a device serving as a power source of a ship, for example. The fuel tank 3 is a main tank provided in a storage space of a ship or the like, and stores therein fuel oil such as diesel oil.

A service tank 5 is disposed downstream of the fuel tank 3, where a discharge port of the fuel tank 3 is connected to the upstream end of the fuel supply passage 4. The service tank 5 is a tank into which the fuel is transported using a gear pump or the like from the fuel tank 3, by an amount to be used, to the vicinity of where the fuel is used, as the supply to the engine body 2.

Provided downstream of the service tank 5 are a feed pump 6, and a first filter 7 and a second filter 8 that are disposed upstream and downstream of the feed pump 6, respectively. The feed pump 6 is a pump for supplying the fuel in the service tank 5 into an injection pump of the engine body 2. The first filter 7 and the second filter 8 are metal filters for removing dusts and the like included in the fuel supplied to the feed pump 6, and are capable of removing dusts having sizes of several millimeters or so.

The fuel supply passage 4 is a pipe made of metal or resin, and the fuel tank 3, the service tank 5, the first filter 7, the feed pump 6, and the second filter 8 are connected to the fuel supply passage 4. An injection pump (not illustrated) is provided to the engine body 2 that is connected to the downstream end of the fuel supply passage 4, and the engine body 2 is driven by combustions of the fuel injected by the injection pump.

Exhaust gas from the engine body 2 is passed through an exhaust pipe 9, and sent to an emission control device 14 where a NOₓ reduction catalyst is provided. The exhaust gas having NOₓ removed by the emission control device 14 is sent to an air separator 15 that separates the air from the exhaust gas.

Part of the air separated in the air separator 15 is sent back into the fuel supply passage 4. As the air separated by the air separator 15 becomes mixed with the fuel, the gaseous body dissolved in the fuel goes through thermal expansion at the time of combustion in the engine body 2, and scatters inside the cylinder. With this, because fine particles of the fuel expand and rupture from inside, and scatter as finer particles, the fuel particles combust all at once. Because the particles of the fuel combust all at once, the fuel particles combust without reaching a high temperature, so that NOx can be reduced.

A fine bubble generation device 11 is disposed in the midway of the fuel supply passage 4. The fine bubble generation device 11 is a device that supplies a gaseous body in the form of fine bubbles into the fuel. As the fine bubble generation device, a jet flow type, a gas-liquid two-phase swirling flow type, or a Venturi type fine bubble generation device may be used. In this embodiment, the fine bubble generation device 11 includes a fine bubble generation medium 24 that is a carbon-based porous material.

In this embodiment, two fine bubble generation media 24 are disposed in parallel. The fine bubble generation medium 24 is a device that generates fine bubbles by discharging a gaseous body having been pressure-fed thereinto, into the fuel through fine pores 24A. The fine bubbles are bubbles with sizes (diameters) smaller than 100 μm at normal temperature and normal pressure, and in particular, bubbles with sizes in a range of several hundred nanometers to several micrometers. A fine bubble is a bubble the surface of which is negatively charged, and covered by a shell of condensed ions. With this negative charge, the fine bubbles are in constant Brownian motion, and, because the force of this motion is greater than the buoyancy of the bubbles, the fine bubbles exhibit a property of remaining in the fuel for an extended length of time.

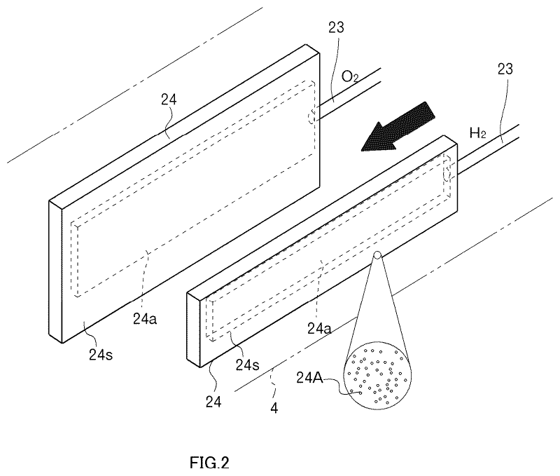

As illustrated in FIG. 2, the fine bubble generation media 24, 24 are disposed in a manner connected to gaseous body passage 23. The fine bubble generation medium 24 has a polygonal shape or an ellipsoidal shape. The fine bubble generation medium 24 includes a main surface 24s that is the largest surface, among the polygonal surfaces (a spherical surface nearest to a flat plane, in the case of an ellipsoidal shape). The main surface 24s is positioned in parallel with the direction in which the fuel flows through the fuel supply passage 4 (the direction of the arrow filled with black in FIG. 2). The fine bubble generation medium 24 has an internal space 24a.

The fine bubble generation medium 24 is made of a carbon-based porous material, and has a large number of fine pores 24A having diameters of several micrometers to several tens of micrometers, as illustrated in FIG. 2. The fine bubble generation medium 24 is a conductive body, and bubbles generated in the fine bubble generation medium 24 become negatively charged. In other words, as the fine bubbles pass through the fine bubble generation medium 24, which is a conductive body, free electrons become attached to the fine bubbles, so that the fine bubbles become negatively charged. By being negatively charged, the bubbles repel each other and are prevented from coalescing into a large bubble.

The carbon-based porous material contains only carbon, or is a composite material containing carbon and ceramic, and is an inorganic material. On the surface of the carbon-based porous material, a film having a thickness of several nanometers is formed. This film is an inorganic film containing silicon. The carbon-based porous material has resistance against oxidation, and does not get rusted or deteriorate due to the oxidation, even after being placed in the fuel supply passage 4 for an extended length of time. Furthermore, the surface has an inorganic film containing silicon and has a property not easily allowing the formation of a paraffinic film.

The gaseous body sent to the internal space 24a passes through the fine pores 24A formed in the fine bubble generation medium 24 and having diameters of several micrometers to several tens of micrometers, and is carried to the surface of the fine bubble generation medium 24. The gaseous bodies having moved to the surface of the fine bubble generation medium 24 turn into fine bubbles, and are discharged into the fuel by the flow of the fuel passing through the fuel supply passage 4.

Examples of the gaseous bodies supplied to the respective fine bubble generation media 24 in the fine bubble generation device 11 include hydrogen, oxygen, the air, ozone, and nitrogen. In this embodiment, hydrogen and oxygen are supplied to the respective fine bubble generation media 24, so that the hydrogen and the oxygen are discharged in the form of fine bubbles.

The internal combustion engine 1 further includes an electrolyzer 21 for supplying hydrogen and oxygen to the respective fine bubble generation media. The electrolyzer 21 is a device that generates hydrogen from water, and is configured as an alkaline or a PEM (polymer membrane) electrolyzer. An alkaline electrolyzer produces hydrogen by electrolyzing an aqueous solution of potassium hydroxide. A polymer electrolyte membrane electrolyzer produces hydrogen, with a polymer electrolyte menbrane (PEM) disposed between an electrode 21a and an electrode 21a, by electrolyzing water. In this embodiment, a PEM electrolyzer is used.

H₂ and O₂ generated from the water by the electrolyzer 21 are generated in a molar ratio of 2:1. Therefore, preferably, the fine bubble generation medium 24 supplying H₂ in the form of fine bubbles has a surface area twice the surface area of the fine bubble generation medium 24 supplying O₂ in the form of fine bubbles.

H₂ and O₂ generated in the electrolyzer 21 are sent to the internal spaces 24a of the respective fine bubble generation media 24, through the gaseous body passage 23. Compressors that are pressure boosters 22 are provided in the midway of the gaseous body passage 23, and are enabled to pressure-feed H₂ and O₂, respectively, at pressures higher than the air pressure by 0.5 MPa to 1.0 MPa.

A method for operating the internal combustion engine 1 according to the present invention will now be explained. When the internal combustion engine 1 according to the present invention is operated, the feed pump 6 is operated to supply the fuel from the fuel tank 3 through the fuel supply passage 4 via the service tank 5. The hydrogen and the oxygen from the fine bubble generation media 24 in the fine bubble generation device 11, which is provided in the midway of the fuel supply passage 4, are mixed in the form of fine bubbles with the fuel. Because the hydrogen and the oxygen mixed with the fuel, in the form of fine bubbles, are charged, as a property of fine bubbles, the bubbles do not coalesce so easily. Because the chances at which these different gaseous bodies coalesce are reduced, these gaseous bodies are allowed to remain dissolved as the respective gas bodies in the fuel.

The reformed fuel obtained by mixing fine bubbles of hydrogen and oxygen is supplied to the injection nozzle of the engine body 2, after having the dusts and the like filtered by the downstream first filter 7 and second filter 8. Because the sizes of the fine bubbles in the reformed fuel are small enough, the fine bubbles pass through the first filter 7 and the second filter 8.

By mixing the fine bubbles, charging efficiency is improved. By increasing the charging efficiency, combustion in the engine body 2 is improved. Furthermore, with the fine bubbles mixed, due to the physical effects such as reduced viscosity and surface tension of the diesel oil, and promoted atomization of sprayed droplets, and due to the chemical effects such as increased oxygen content and radical content, the fuel economy is improved.

In addition, because non-uniformity of the diffusion combustion is reduced by mixing fine bubbles, soot, which is a disadvantageous feature of a diesel engine, is reduced. With the graphite reduced, PM resulting from the soot is also reduced.

The exhaust gas from the engine body 2 has NOₓ removed in the emission control device 14, and a part of the air is separated by the air separator, and is supplied to the fuel. The air separated by the air separator is supplied through the ordinary nozzle. The bubbles of this air contribute to the reduction of NOₓ, as the gaseous body dissolved in the fuel goes through thermal expansion, and scatters in the cylinder.

As described above, the internal combustion engine 1 generates reformed fuel by mixing a gaseous body in the form of fine bubbles with the fuel from the fuel tank 3, and supplies the reformed fuel to the engine body 2. The internal combustion engine 1 includes the fuel supply passage 4 that supplies the fuel from the fuel tank 3 to the engine body 2, and the fine bubble generation device 11 that discharges a plurality of gaseous bodies in the form of fine bubbles into the fuel to be supplied to the engine body 2. The fine bubble generation device 11 includes fine bubble generation media 24, 24 that are porous materials. Each of the fine bubble generation media 24, 24 has a main surface 24s having the largest area on a plane parallel with a direction in which the fuel flows through the fuel supply passage 4.

With such a configuration, because gaseous bodies of different components can be mixed in the fuel, gaseous bodies that become combustible by being mixed, such as hydrogen and oxygen, can be supplied individually. Combustion efficiency is improved with the fuel reformed by mixing fine bubbles therein from the fine bubble generation device 11 disposed in the fuel supply passage 4, so that it is possible to suppress generation of harmful gas generated as a result of incomplete combustion of nitrogen oxide, carbon monoxide, and the like.

The fine bubble generation device 11 is disposed in the midway of the fuel supply passage 4.

With such a configuration, by making the maximum use of the flow of the fuel that comes into contact with the fine bubble generation media 24, it is possible to separate the fine bubbles from the fine bubble generation media 24.

Furthermore, a plurality of internal spaces 24a, 24a into which two or more gaseous bodies are supplied are formed; and, by discharging a plurality of different types of gaseous bodies from the plurality of respective internal spaces 24a, 24a, the plurality of gaseous bodies are discharged in the form of fine bubbles.

With such a configuration, because gaseous bodies of different components can be mixed in the fuel, gaseous bodies that become combustible by being mixed, such as hydrogen and oxygen, can be supplied individually.

The fine bubble generation device 11 includes a plurality of fine bubble generation medium 24, 24, and the plurality of fine bubble generation medium 24, 24 have surface areas that are different from each other.

With such a configuration, because gaseous bodies of different components can be mixed with the fuel at a desired ratio, gaseous bodies that become combustible by being mixed, such as hydrogen and oxygen, can be supplied individually.

The gaseous bodies supplied to the fine bubble generation device 11 are hydrogen and oxygen. With such a configuration, although hydrogen is more combustible when the hydrogen and oxygen are supplied as a mixture into a fuel, it is possible to, by supplying the hydrogen and oxygen to the fuel in the form of fine bubbles, let the individual gaseous bodies remain inside the bubbles, so that the hydrogen is supplied to the engine body 2 without combusting.

Furthermore, the electrolyzer 21 that generates hydrogen and oxygen by electrolyzing water is further provided, and the hydrogen and the oxygen supplied to the fine bubble generation device 11 are supplied from the electrolyzer 21.

With this configuration, the fuel can be reformed using hydrogen and oxygen generated using water that exists in nature. Furthermore, the gaseous bodies can be mixed at the ratio at which the hydrogen and the oxygen are generated, so that a reformed fuel capable of improving the performance of the engine body 2 can be generated.

Furthermore, the air separator 15 that separates air from the exhaust gas from the internal combustion engine 1 is provided, and the air separator 15 supplies the air into the fuel supply passage 4.

With such a configuration, by mixing the air separated by the air separator 15 with the fuel, the gaseous body dissolved in the fuel goes through thermal expansion at the time of combustion inside the engine body 2, and scatters in the cylinder. With this, because fine particles of the fuel expand and rupture from inside, and scatter as finer particles, the fuel particles combust all at once. Because the particles of the fuel combust all at once, the fuel particles combust without reaching a high temperature, so that NOₓ can be reduced.

### Second Embodiment

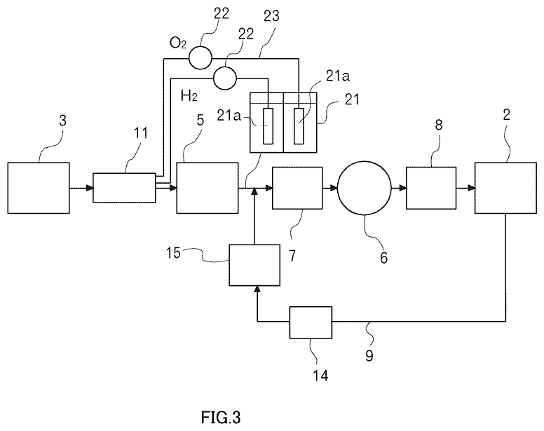

In a second embodiment, as illustrated in FIG. 3, the fine bubble generation device 11 is disposed upstream of the service tank 5. With such a configuration, it is possible to mix the fine bubbles with the fuel in the service tank 5, and therefore, the reformed fuel can be stored in the service tank 5.

The fuel stored in the service tank 5 can also be supplied to other drive devices as well as to the engine body 2. With such a configuration, the reformed fuel can be used for various purposes in a large vehicle having a plurality of drive devices such as a ship.

### Other Examples of Gaseous Bodies Used for Reforming

In the embodiment, the reformed fuel is generated by mixing fine bubbles of hydrogen and oxygen with the fuel, but the gaseous bodies used for reforming are not limited thereto, and may be, for example, ozone and oxygen. Because ozone reacts with oxygen in the cylinder and turns into a peroxide, the combustion is promoted and the heat generation rate is improved. Furthermore, because the combustibility can be maintained with corona discharge while reducing the combustion temperature with the transport of OH radicals, it is possible to reduce NOₓ.

### Third Embodiment

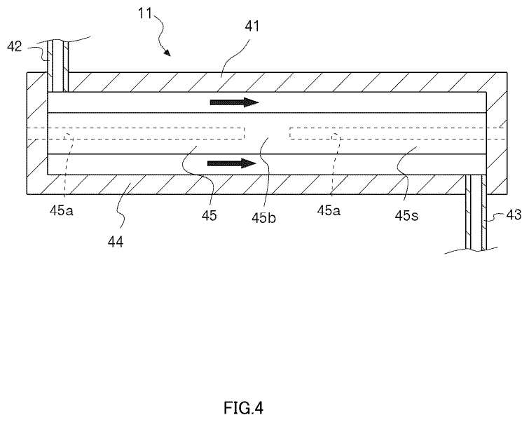

Furthermore, in a third embodiment, as illustrated in FIG. 4, the fine bubble generation device 11 may be configured as a piping unit 41 disposed in the midway of the fuel supply passage 4. The piping unit 41 includes an incoming pipe 42 and an outgoing pipe 43 that are connected to the fuel supply passage 4, a pipe 44 through which the fuel incoming from the incoming pipe 42 is passed, and a plate-shaped fine bubble generation medium 45 provided inside the pipe 44.

In the fine bubble generation medium 45, two internal spaces 45a, 45a are provided in a manner stretching between the respective ends in the longitudinal direction and the central part. The internal spaces 45a, 45a are separated by a partition wall 45b provided at the center in the longitudinal direction of the fine bubble generation medium so that the gaseous bodies flowing into the two respective internal spaces 45a, 45a do not become mixed in the fine bubble generation medium 45. The partition wall 45b is formed using a wall surface of the fine bubble generation medium 45, and is a part of the fine bubble generation medium 45.

The fine bubble generation medium 45 includes a main surface 45s that is the largest surface, among the polygonal surfaces (a spherical surface nearest to a flat plane, in the case of an ellipsoidal shape). The main surface 45s is positioned in parallel with the direction in which the fuel flows through the pipe 44 (the direction of the arrow filled with black in FIG. 4).

The fine bubble generation medium 45 is made of a carbon-based porous material, and has a large number of fine pores having diameters of several micrometers to several tens of micrometers. The fine bubble generation medium 45 is a conductive body, and bubbles generated in the fine bubble generation medium 45 become negatively charged. In other words, as the fine bubbles pass through the fine bubble generation medium 45, which is a conductive body, free electrons become attached to the fine bubbles, so that the fine bubbles become negatively charged. By being negatively charged, the bubbles repel each other and are prevented from coalescing into a large bubble.

The carbon-based porous material contains only carbon, or is a composite material containing carbon and ceramic, and is an inorganic material. On the surface of the carbon-based porous material, a film having a thickness of several nanometers is formed. This film is an inorganic film containing silicon. The carbon-based porous material has resistance against oxidation, and does not get rusted or deteriorate due to the oxidation, even after being placed in the pipe 44 for an extended length of time. Furthermore, the surface has an inorganic film containing silicon and has a property not easily allowing the formation of a paraffinic film.

The two types of gaseous bodies sent to the respective internal space 45a, 45a pass through the fine pores provided in the fine bubble generation medium 45 and having diameters of several micrometers to several tens of micrometers, and are carried to the surface of the fine bubble generation medium 45. The gaseous bodies having moved to the surface of the fine bubble generation medium 45 turn into fine bubbles, and are discharged into the fuel by the flow of the fuel passing through the pipe 44.

Examples of the gaseous bodies supplied to the fine bubble generation medium 45 in the fine bubble generation device 11 include hydrogen, oxygen, the air, ozone, and nitrogen. In this embodiment, hydrogen and oxygen are supplied to the respective fine bubble generation medium, so that the hydrogen and the oxygen are discharged in the form of fine bubbles.

With such a configuration, with the use of one fine bubble generation medium 45, two types of gaseous bodies can be individually discharged into the fuel in the form of fine bubbles.

### Fourth Embodiment

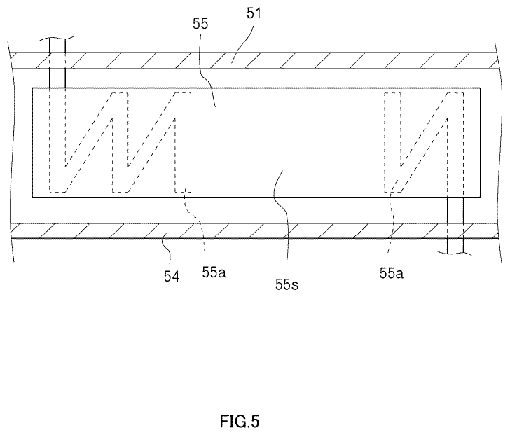

Furthermore, in a fourth embodiment, as illustrated in FIG. 5, the fine bubble generation device 11 may be configured as a piping unit 51 disposed in the midway of the fuel supply passage 4. The piping unit 51 includes a pipe 54 connected to the fuel supply passage 4, and a plate-shaped fine bubble generation medium 55 provided inside the pipe 54.

The fine bubble generation medium 55 has two internal spaces 55a, 55a. The internal spaces 55a, 55a are provided separately on respective sides of the fine bubble generation medium 55 in the longitudinal direction. One internal space 55a includes a plurality of passages extending in the lateral direction and another passage provided as a diagonal connecting these passages, and delineates an “N” shape in a side view, or has a shape including two horizontally reversed “Ns” that are arranged side by side. The two internal spaces 55a, 55a are configured so that the gaseous bodies flowing thereinto do not get mixed in the fine bubble generation medium 55.

The fine bubble generation medium 55 includes a main surface 55s that is the largest surface, among the polygonal surfaces (a spherical surface nearest to a flat plane, in the case of an ellipsoidal shape). The main surface 55s is positioned in parallel with the direction in which the fuel flows through the pipe 54 (the direction of the arrow filled with black in FIG. 5).

The fine bubble generation medium 55 is made of a carbon-based porous material, and has a large number of fine pores having diameters of several micrometers to several tens of micrometers. The fine bubble generation medium 55 is a conductive body, and bubbles generated in the fine bubble generation medium 55 become negatively charged. In other words, as the fine bubbles pass through the fine bubble generation medium 55, which is a conductive body, free electrons become attached to the fine bubbles, so that the fine bubbles become negatively charged. By being negatively charged, the bubbles repel each other and are prevented from coalescing into a large bubble.

The carbon-based porous material contains only carbon, or is a composite material containing carbon and ceramic, and is an inorganic material. On the surface of the carbon-based porous material, a film having a thickness of several nanometers is formed. This film is an inorganic film containing silicon. The carbon-based porous material has resistance against oxidation, and does not get rusted or deteriorate due to the oxidation, even after being placed in the pipe 54 for an extended length of time. Furthermore, the surface has an inorganic film containing silicon and has a property not easily allowing the formation of a paraffinic film.

The two types of gaseous bodies sent to the respective internal space 55a, 55a pass through the fine pores provided in the fine bubble generation medium 55 and having diameters of several micrometers to several tens of micrometers, and are carried to the surface of the fine bubble generation medium 55. At this time, because the internal spaces 55a are ensured to have some lengths, the gaseous bodies have some chance to come into contact with a larger number of pores in the fine bubble generation medium 55. The gaseous bodies having moved to the surface of the fine bubble generation medium 55 turn into fine bubbles, and are discharged into the fuel by the flow of the fuel passing through the pipe 54.

Examples of the gaseous bodies supplied to the fine bubble generation medium 55 in the fine bubble generation device 11 include hydrogen, oxygen, the air, ozone, and nitrogen. In this embodiment, hydrogen and oxygen are supplied to the respective fine bubble generation medium, so that the hydrogen and the oxygen are discharged in the form of fine bubbles.

With such a configuration, with the use of one fine bubble generation medium 55, two types of gaseous bodies can be individually discharged into the fuel in the form of fine bubbles.

### Fifth Embodiment

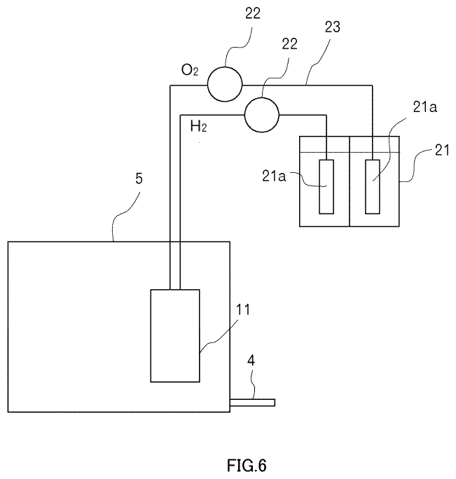

In a fifth embodiment, as illustrated in FIG. 6, the fine bubble generation device 11 may be disposed inside the service tank 5. Inside the service tank 5, the fine bubble generation device 11 for supplying fine bubbles into the fuel stored in the service tank 5 is disposed. The fine bubble generation device 11 supplies fine bubbles of a plurality of types of gaseous bodies sent from respective gaseous body passages 23, 23, to the fuel.

The internal combustion engine 1 further includes the electrolyzer 21 for supplying hydrogen and oxygen to the fine bubble generation device 11. The electrolyzer 21 is a device that generates hydrogen from water, and is configured as an alkaline or a PEM (polymer membrane) electrolyzer. An alkaline electrolyzer produces hydrogen by electrolyzing an aqueous solution of potassium hydroxide. A polymer electrolyte membrane electrolyzer produces hydrogen, with a polymer electrolyte menbrane (PEM) disposed between an electrode 21a and an electrode 21a, by electrolyzing water. In this embodiment, a PEM electrolyzer is used.

H₂ and O₂ generated in the electrolyzer 21 are sent to the fine bubble generation device 11, through the gaseous body passage 23. Compressors that are pressure boosters 22 are provided in the midway of the gaseous body passage 23, and are enabled to pressure-feed H₂ and O₂, respectively, at pressures higher than the air pressure by 0.5 MPa to 1.0 MPa.

With this configuration, two types of gaseous bodies can be individually discharged into the fuel stored in the service tank 5, in the form of fine bubbles.

### Sixth Embodiment

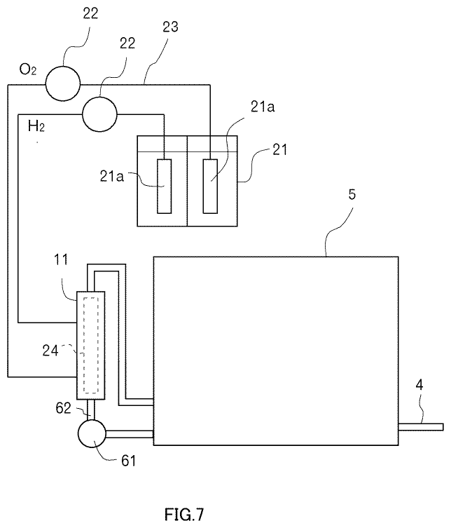

Furthermore, in a sixth embodiment, as illustrated in FIG. 7, the fine bubble generation device 11 may be disposed in a circulation passage 62 for circulating the fuel in the service tank 5. To the service tank 5, a circulation pump 61 and the circulation passage 62 for circulating the fuel in the service tank 5 are connected. The fine bubble generation device 11 is disposed in the midway of the circulation passage 62.

The internal combustion engine 1 further includes the electrolyzer 21 for supplying hydrogen and oxygen to the fine bubble generation medium 24 in the fine bubble generation device 11. The electrolyzer 21 is a device that generates hydrogen from water, and is configured as an alkaline or a PEM (polymer membrane) electrolyzer. An alkaline electrolyzer produces hydrogen by electrolyzing an aqueous solution of potassium hydroxide. A polymer electrolyte membrane electrolyzer produces hydrogen, with a polymer electrolyte menbrane (PEM) disposed between an electrode 21a and an electrode 21a, by electrolyzing water. In this embodiment, a PEM electrolyzer is used.

H₂ and O₂ generated in the electrolyzer 21 are sent to the fine bubble generation device 11, through the gaseous body passage 23. Compressors that are pressure boosters 22 are provided in the midway of the gaseous body passage 23, and are enabled to pressure-feed H₂ and O₂, respectively, at pressures higher than the air pressure by 0.5 MPa to 1.0 MPa.

With such a configuration, fine bubbles can be supplied using the flow of the fuel circulating from the service tank 5 and passing through the circulation passage 62. Inside the circulation passage 62, the fine bubble generation device 11 for supplying fine bubbles is disposed. The fine bubble generation device 11 supplies fine bubbles of a plurality of types of gaseous bodies sent from respective gaseous body passages 23, 23, to the fuel.

With this configuration, two types of gaseous bodies can be individually discharged into the fuel stored in the service tank 5, in the form of fine bubbles.

### REFERENCE SIGNS LIST

1 internal combustion engine
2 engine body
3 fuel tank
4 fuel supply passage
5 service tank
6 feed pump
7 first filter
8 second filter
9 exhaust pipe
11 fine bubble generation device
14 emission control device
15 air separator
21 electrolyzer
21a electrode
23 gaseous body passage
24 fine bubble generation medium
24a internal space
24s main surface
24A pores

1. An internal combustion engine that generates reformed fuel by mixing a gaseous body in a form of fine bubbles with a fuel from a fuel tank, and supplies the reformed fuel into an engine body, the internal combustion engine comprising:
a fuel supply passage through which the fuel is supplied from the fuel tank to the engine body; and
a fine bubble generation device that discharges a plurality of gaseous bodies in the form of fine bubbles to the fuel to be supplied to the engine body, wherein
the fine bubble generation device includes a fine bubble generation medium that is a porous material, and
the fine bubble generation medium has a main surface having a largest area on a surface parallel with a direction in which the fuel flows.

2. The internal combustion engine according to claim 1, wherein the fine bubble generation device is disposed in midway of the fuel supply passage.

3. The internal combustion engine according to claim 1, wherein
the fine bubble generation medium has a plurality of internal spaces into which two or more gaseous bodies are supplied, and
by discharging a plurality of different types of gaseous bodies from the plurality of respective internal spaces, a plurality of gaseous bodies are discharged in the form of fine bubbles.

4. The internal combustion engine according to claim 1, wherein the fine bubble generation device includes a plurality of fine bubble generation media, and the plurality of fine bubble generation media have respective surface areas that are different from each other.

5. The internal combustion engine according to claim 1, wherein the gaseous bodies supplied to the fine bubble generation device are hydrogen and oxygen.

6. The internal combustion engine according to claim 5, further comprising an electrolyzer that generates hydrogen and oxygen by electrolyzing water, wherein
hydrogen and oxygen to be supplied to the fine bubble generation device are supplied from the electrolyzer.

7. The internal combustion engine according to claim 1, further comprising an air separator that separates air from exhaust gas of the internal combustion engine, wherein
the air is supplied from the air separator to the fuel supply passage.
